(19) United States
(12) Patent Application Publication
(10) Pub. No.: US 2017/0136732 A1
(43) Pub. Date: May 18, 2017

(54) Film for Airbag Applications

(71) Applicant: Benecke-Kalico AG, Hannover (DE)

(72) Inventors: Volker Hülsewede, Schlat (DE); Joseph Mani, Eislingen (DE); Thomas Malner, Göppingen (DE); Jürgen Bühring, Wedemark (DE)

(73) Assignee: Benecke-Kalico AG, Hannover (DE)

(21) Appl. No.: 15/323,358

(22) PCT Filed: May 13, 2015
(86) PCT No.: PCT/EP2015/060573

§ 371 Date: Jan. 3, 2017

(30) Foreign Application Priority Data
Jul. 17, 2014 (DE) 10 2014 213 974.0

(51) Int. Cl. B32B 5/18; B60R 21/215; B32B 27/40; B32B 27/30; B32B 27/06; B32B 27/32

(52) U.S. Cl. CPC B32B 5/18; B32B 27/065; B32B 27/32; B32B 27/40; B32B 27/304; B60R 21/215; B32B 2605/00; B32B 2571/00; B32B 2307/308; B32B 2266/025; B32B 2266/0278; B32B 2266/0235; B32B 2255/26; B32B 2255/102; B32B 2250/24; B32B 2250/02

(57) ABSTRACT

The invention relates to a foam-film laminate (1) comprising a compact cover layer with a three-dimensionally-structured or smooth surface (6) on the upper side and a foam layer (5) on the underside of the cover layer, said cover layer (2) comprising an outer layer (3) and an inner layer (4), the outer layer (3) having a thickness in the range of 0.05 to 0.3 mm, the inner layer (4) having a thickness in the range of 0.2 to 0.6 mm and being bonded to the foam layer (5), and said foam layer having a thickness in the range of 0.5 to 2 mm and a density of at least 350 kg/m³. The foam-film laminate is particularly suitable for coating interior trim parts for a motor vehicle in the region of the airbag coverings and in the region of the tear seams of the airbag coverings.

The invention relates to a foam-film laminate for coating components, such as the interior trim of motor vehicles, in particular airbag coverings, to the use thereof, and to interior trim parts of motor vehicles which are coated with the foam-film laminate.

In the field of polyolefin-based decorative surface materials, substantially two structures are used at present. For applications and components in which the surface material is subjected to pronounced stretching (e.g. >200%) in subsequent thermal shaping processes, compact film structures, which can be composed of a plurality of layers, are preferably used. These materials generally have a density of >800 kg/m³ with a thickness of from 0.5 to 3.0 mm, so that the components have a correspondingly high weight and, associated therewith, a high requirement in terms of raw materials.

For applications and components in which the surface material is subjected to low stretching (e.g. <200%) in subsequent thermal shaping processes, surface materials having at least one foamed layer, so-called foam films, can be used. The compact cover layer can be reduced and formed with a thickness of from 0.2 to 0.8 mm with a density of >800 kg/m³. The foamed layer is generally formed with a density of from 20 to 200 kg/m³ and a thickness of from 0.5 to 4.0 mm. The foamed layer reacts resiliently when pressure is applied, so that the components have pleasant haptics under pressure. Owing to the low density of the foamed layer, the weight of the components is reduced, as is the requirement in terms of raw materials necessary for production.

These surface structures are used to produce components for automotive interiors, inter alia instrument panels, by thermoforming methods. If these components contain so-called invisible airbag systems, the film materials must exhibit a required tearing behavior, whereby deployment of the airbag must take place within defined time periods, flying particles are avoided, and protection for the passenger is ensured. To that end, the current prior art provides that the decorative film is weakened on the rear side. The weakening is often visible on the decorative side in the form of a line. Furthermore, the production of the components requires a second working step, in addition to the lamination of the carrier materials, in which the structure is weakened.

Accordingly, the airbag covering of a component, for example an instrument panel, is at present produced using a two-ply compact film structure comprising an inner and an outer layer, which is first thermoformed by the positive or negative deep-drawing method. A PUR-based foam is then applied to the back of the skin so produced, and this foam is at the same time connected to a stable carrier element.

In these structures, the airbag cover is pushed against the PUR foam by the bag when the airbag opens, and the PUR foam breaks. As the process continues, the cover comes into contact with the compact inner layer of the two-ply compact film structure which, owing to its significantly higher strength and extensibility, does not break immediately but is first stretched. The upper layers of the foam hereby break, with the result that further extensible material becomes available. As a consequence of this debris, the total distance over which stretching must take place before breaking occurs becomes significantly longer. The time taken for the airbag to open is thereby lengthened to an unacceptable degree. Furthermore, so-called ballooning causes a risk of inadmissible flying particles. In order to counteract this, a weakening is introduced according to the prior art on the rear side of the film, with the mentioned disadvantages.

WO 2012/100880 describes a method of producing foam-film laminates comprising a compact cover layer and a foam layer, which laminates are sufficiently stable during deep-drawing even at relatively high degrees of stretching of over 300% and can be thermally shaped. However, tests of the opening behavior necessary for airbag applications conducted with these foam-film laminates in the unweakened state have shown that the opening behavior is not adequate for safe airbag use. A significant disadvantage are the flying particles which occurred, in particular at a test temperature of +85° C., as a result of constrictions formed due to the ballooning effect which is known to occur when airbags open.

The object of the invention is to overcome the above-mentioned disadvantages of the films according to the prior art. In particular, the object consists in providing a film which is suitable for decorating components, in particular components for the interior trim of motor vehicles, in particular airbag coverings, and which does not require a weakening. In particular, the film is also to have sufficient stability for thermal shaping processes with a relatively high degree of stretching (e.g. greater than 200%). Furthermore, great freedom of design is to be ensured, and the material consumption for production and the energy consumption for shaping are to be minimized

Surprisingly, it has been possible to achieve the object by means of a foam-film laminate having the features of claim 1. The foam-film laminate 1 according to the invention therefore comprises a compact cover layer 2 having a three-dimensionally structured or smooth surface 6 on the upper side and a foam layer 5 on the lower side of the cover layer, wherein the cover layer 2 has an outer layer 3 and an inner layer 4, the outer layer 3 has a thickness in the range of from 0.05 to 0.3 mm, the inner layer 4 has a thickness in the range of from 0.2 to 0.6 mm and is bonded to the foam layer 5, and the foam layer 5 has a thickness in the range of from 0.5 to 2 mm and a density of at least 350 kg/m³.

The outer compact layer 3 provides for the properties necessary for the method of processing the film, such as, for example, grain stability in positive thermoforming or moldability in negative thermoforming or the IMG method, and provides the use properties of the film, such as mechanical, haptic or optical properties. The inner compact layer 4 permits a significantly reduced elongation at break at the speeds and temperatures that are important for airbag opening. A further reduction of the mentioned mechanical properties is achieved by the foam layer 5.

The foam-film laminate according to the invention has a tearing behavior which satisfies the requirements in the case of corresponding airbag opening, without the foam-film laminate or decorative material having to be weakened. On the one hand, visibility of the weakening line, which is seen as a flaw in the design, is hereby avoided. The important advantage, however, is that the manufacturer of the component is able to avoid costs relating to the acquisition and operation of equipment for introducing weakening lines.

Furthermore, the weight and thus the raw material consumption are reduced by the structure of layers with reduced thickness. Owing to the small thickness of the outer compact layer 3, the material base in that layer can be so chosen that customer-specific requirements, such as surface resistance, gloss, graining, ageing resistance, etc., can be met without the tearing behavior of the outer layer 3 having to be taken into consideration (freedom of design). The inner compact layer 4 decisively supports these mentioned properties, which cannot be achieved by the sole use of a conceivable foamed layer analogous to the foam layer 5.

Furthermore, owing to the compact form of the outer layer 3 and inner layer 4, this structure as a whole offers a higher heat capacity in comparison with a predominantly foamed structure. As a result, the heat loss in the thermoforming processes from the heating step to the shaping step is smaller and the material remains moldable. In the IMG process, this leads to improved grain molding. In the positive thermoforming process, better grain preservation is achieved.

A further advantage is that the foam-film laminate according to the invention can also be shaped with a relatively high degree of stretching, for example greater than 200%, so that complex component shapes can also be coated with the film.

The foam-film laminate according to the invention can be a thermoplastic foam-film laminate. A preferred foam-film laminate is an electron-beam-crosslinked foam-film laminate in which the foam-film laminate is crosslinked by treatment with electron beams. A state of the film is thereby obtained in which a grain stability that is advantageous for the positive deep-drawing process can be achieved. The foam-film laminate according to the invention comprises a compact cover layer which in the case of a laminate for positive deep-drawing can be configured with a three-dimensionally structured surface on the upper side and a foam layer on the lower side of the cover layer. In the case of a laminate for negative deep-drawing, the compact cover layer can also be configured without a three-dimensional surface structure. The foam-film laminate is a film which has a two-ply compact cover layer and a foam layer bonded thereto. The foam layer is also referred to as a foamed layer. The compact cover layer can also be referred to as a decorative layer or compact film.

The compact cover layer is two-ply and has an outer layer and an inner layer. The outer layer is bonded to the inner layer, and the foam layer is bonded to the inner layer, so that a three-ply composite structure is obtained. Bonding between the outer layer and the inner layer and between the inner layer and the foam layer can be carried out in the conventional manner, for example thermally or by adhesive bonding.

The compact cover layer or outer layer of the cover layer has on the upper side a smooth surface or a three-dimensionally structured surface, namely a so-called patterning or graining, which is possible in a very wide variety of forms and designs and which serves the purpose of decoration. Moldings and shaped films or skins comprising a compact cover layer and a foam layer for the interior trim of motor vehicles are widely known. The foam-film laminate according to the invention can be used as a molding or a shaped film or skin.

Various methods for forming the three-dimensionally structured surface are known in the prior art, for example embossing methods or rolling methods for producing “endless” film strips or also methods for producing off-tool individual shaped skins. An example thereof is the “in-mold graining method (IMG method)”, which has developed as a special method from the negative deep-drawing method. This in-mold graining method, which has hitherto been known substantially by its English name, is probably best translated by the expression “graining negative deep-drawing”. In contrast to the standard deep-drawing method, in which molding to the three-dimensional geometric structure of the component is carried out by introducing into the film a deep-drawing stamp that forms the later component contour, in the case of negative deep-drawing a film is drawn into a negative mold, for example by vacuum. The in-mold graining method is thereby a particular form of negative deep-drawing in which not only the geometric structure of the component but also the later grain structure is introduced into the tool surface as a negative.

The foam-film laminate according to the invention is particularly suitable for and directed to the production of components by the IMG method or the positive deep-drawing method as well as laminate production by the rolling method or embossing method. The laminates produced can be subjected to a crosslinking step, preferably after introduction of the three-dimensional surface structure, in particular electron beam crosslinking.

Crosslinking of the laminate can be carried out with high-energy radiation, preferably electron radiation. This leads to very good grain stability in deep drawing and to very good deep-drawing properties. Irradiation leads to crosslinking in the plastics material.

The foam-film laminate can accordingly be shaped into a component, wherein the shape of the component is preferably obtainable by applying the foam-film laminate in a shaping method step to a carrier that corresponds to the shape of the component. For application of the foam-film laminate to a carrier, for example a dashboard carrier, there are known, in addition to deep drawing, such as, for example, the methods mentioned above, a number of further shaping methods, such as, for example, compression or pressing methods, in which the film is pressed against molds or against the mentioned carriers and acquires its component shape. The surface structure can be brought into the desired shape, for example, by thermoforming, in-mold graining or low-pressure molding.

The outer layer of the cover layer has a thickness in the range of from 0.05 to 0.3 mm. The inner layer of the cover layer has a thickness in the range of from 0.2 to 0.6 mm. The foam layer has a thickness in the range of from 0.5 to 2 mm.

These layers or films of the cover layer thus on the one hand are still not too thin, so that a qualitatively good grain is obtained during formation of the three-dimensionally structured surface, for example by the IMG method or by positive deep-drawing, and on the other hand have a thickness which does not have too great an effect on the material costs. These film thicknesses/forms can naturally be adjusted and produced using very different tools.

Compact layers or films are understood as being layers or films having a density of greater than 800 kg/m³. Compact layers are in particular non-foamed layers. Foam layers generally have densities of less than 800 kg/m³. Both the outer layer and the inner layer of the compact cover layer are themselves likewise compact layers. The density of the outer layer of the cover layer is in particular greater than 800 kg/m³ and preferably greater than 860 kg/m³. The density of the inner layer of the cover layer is in particular greater than 800 kg/m³ and preferably greater than 860 kg/m³.

The density of the foam layer is at least 350 kg/m³, preferably greater than 500 kg/m³. The density of the foam layer is preferably not more than 700 kg/m³ and more preferably not more than 600 kg/m³. The foam layer preferably has a density in a range of from 350 to 700 kg/m³, preferably from 500 to 700 kg/m³ and particularly preferably from 500 to 600 kg/m³.

The foam layer, with a density of at least 350 kg/m³, has a relatively high density for a foamed layer. It is preferably formed by physical foaming, so that a physically foamed layer is obtained.

The foamed layer is preferably formed by foam extrusion. The layer of foamed plastics material is thereby produced by injecting a blowing agent under pressure, for example an inert gas, into the plastics material melt during the extrusion process above the melting temperature and then relaxing the melt loaded with gas and cooling it below the melting temperature as it leaves the extrusion system. The layer of foamed plastics material is thus produced by injecting blowing agent under pressure into a plastics material melt during the extrusion process and by subsequently relaxing the blowing agent under pressure.

There can be used as blowing agents, for example, H₂O or inert gases, optionally in combination with one another. For the purpose of pronounced foam formation, an inert gas is advantageously used as the blowing agent, or a blowing agent that comprises an inert gas is used. There can be used as inert gases in the method all inert gases known to the person skilled in the art, wherein CO₂ or N₂ has been found to be particularly advantageous in terms of price, environmental compatibility and foaming behavior.

The foam material can then be connected, for example thermally or by adhesive bonding, to the compact two-ply cover layer in the form of a sheet-like material, so that a multi-layer plastics film having a foamed layer is formed. It is also possible first to connect the foam layer to the inner layer and then to apply the outer layer to the inner layer.

The outer layer of the cover layer can be a layer of plastics material or a layer of leather, wherein it is preferably a layer of plastics material. There can be used for the outer layer, for example, a conventional surface material based on leather or plastics material. Conventional additives, such as, for example, lubricants, stabilizers, fillers, such as inorganic fillers, and/or pigments, can be contained in the leather or plastics material of the outer layer. The outer layer can be connected to the inner layer of the cover layer by conventional methods, for example thermally, by adhesive bonding or by other methods.

When the outer layer of the cover layer is a layer of plastics material, the plastics material can be, for example, polyolefin, in particular thermoplastic polyolefin (TPO), polyurethane (PU), for example thermoplastic polyurethanes (TPU), polyvinyl chloride (PVC) or a combination of two or more thereof, wherein TPO is particularly preferred. The use of thermoplastic polyolefins (TPO) is widespread. They are also referred to as olefin-based thermoplastic elastomers.

Examples of polyolefins are polyethylene (PE), polypropylene (PP) and mixtures of polyethylene (PE) and polypropylene (PP).

Polyethylene (PE) is here understood as being such polymers or copolymers in which the proportion by weight of ethylene is >50% by weight. Polypropylene (PP) is here understood as being such polymers or copolymers in which the proportion by weight of propylene is >50% by weight.

Examples of TPO are blends of ethylene-propylene-diene rubber (EPDM) with polyethylene (PE) and/or polypropylene (PP), blends of ethylene-propylene rubber (EPM) with polypropylene (PP) and/or polyethylene (PE) and ethylene-propylene blends.

The inner layer of the cover layer is preferably a layer of plastics material. For the inner layer there can be used, for example, a conventional surface material based on plastics material. The inner layer can be connected to the foam layer by conventional methods, for example thermally, by adhesive bonding or by other methods. Conventional additives, such as, for example, lubricants, stabilizers, fillers, such as inorganic fillers, and/or pigments, can be contained in the plastics material of the inner layer.

Examples of suitable plastics materials for the inner layer are polyolefin, in particular thermoplastic polyolefin (TPO), polyurethane (PU), for example thermoplastic polyurethanes (TPU), polyvinyl chloride (PVC) or a combination of two or more thereof, wherein TPO is particularly preferred. Examples of polyolefins or thermoplastic polyolefins (TPO) have been mentioned above. There are suitable for the foam layer, for example, polyethylene (PE), polypropylene (PP) and mixtures of polyethylene (PE) and polypropylene (PP).

The foam layer is preferably a foamed layer of plastics material. Conventional additives, such as, for example, lubricants, stabilizers, fillers, such as inorganic fillers, and/or pigments, can be contained in the plastics material of the foam layer. Examples of suitable plastics materials for the foam layer are polyolefin, including thermoplastic polyolefin (TPO), polyurethane (PU), for example thermoplastic polyurethanes (TPU), polyvinyl chloride (PVC) or a combination of two or more thereof, wherein polyolefin and/or TPO are particularly preferred. Examples of polyolefins or thermoplastic polyolefins (TPO) have been mentioned above.

In a preferred embodiment, the outer layer, the inner layer and the foam layer (5) are each a layer of plastics material. The plastics materials are preferably thermoplastic plastics materials. Thermoplastic plastics materials also include thermoplastic elastomers, which behave rubber elastically in the range of conventional use temperatures but can be processed like thermoplastics at a higher temperature.

The material composition of the layer material for the outer layer and that of the layer material for the inner layer are in particular different. This can be effected, for example, by varying the nature and/or relative proportions of the polymers used and/or by varying the amount and/or nature of the additives, in particular fillers.

The foam layer advantageously has a breaking strength and ultimate elongation which are significantly below the values for the compact outer layer of the cover layer. The breaking strength and ultimate elongation of the inner layer of the cover layer and/or of the foam layer are preferably lower than the breaking strength and ultimate elongation of the outer layer of the cover layer. Breaking strength and ultimate elongation can be determined by tensile elongation tests in accordance with DIN 527-3. The details regarding the breaking strength and ultimate elongation of the individual layers relate both to the breaking strength and ultimate elongation in the longitudinal direction and to the breaking strength and ultimate elongation in the transverse direction. The longitudinal and transverse directions are perpendicular to one another, wherein the production direction (direction of rolling, extrusion direction) of the film is defined as the longitudinal direction and the direction perpendicular to the production direction is defined as the transverse direction. Ultimate elongation is also referred to as elongation at break.

In a preferred embodiment of the foam-film laminate, the elongation at break, under the conditions of airbag firing, of the inner layer and of the foam layer is lower than the elongation at break of the outer layer, wherein the airbag-relevant conditions are defined as a temperature range between −35 and +85° C. and the occurrence of high elongation rates, governed by the opening speeds of an airbag of up to 90 m/s.

The melt flow index (MFI) as used here is determined in accordance with DIN EN ISO 1133 at a temperature of 230° C. and a load of 2.16 kg. The melt flow index (MFI) is also referred to as the melt flow rate (MFR). The details regarding the MFI of the layers here relate to the layer material used for the particular layer in question.

In a preferred embodiment, the melt flow index (MFI) of the inner layer is greater than the melt flow index (MFI) of the outer layer, wherein it is preferred that the difference between the melt flow index (MFI) of the inner layer and the melt flow index (MFI) of the outer layer is at least 1 g/10 min, preferably at least 2 g/10 min. It is particularly preferred that the outer layer has a melt flow index (MFI) of less than 1 g/10 min and the inner layer has a melt flow index (MFI) of greater than 3 g/10 min.

The MFI values can be adjusted, for example, by the choice of suitable polymers and optionally by the nature and/or amount of fillers used. The person skilled in the art is familiar with the measures for adjusting the MFI value of such layers. The melt flow index correlates, for example, relatively well with the chain length of the polymer molecules or the molecular weight.

By means of the layer film system according to the invention, the ultimate elongation of the structure as a whole is so reduced that a tearing behavior which meets the requirements of an airbag system is achieved, wherein particularly good results are achieved if the MFI values of the outer and inner layers are adjusted as indicated above. A particular advantage of the invention is that this tearing behavior is achieved without having to provide the foam-film laminate with a weakening, which is required according to the prior art. Subsequent processing for the purpose of weakening the rear side by means of predetermined breaking lines, such as, for example, tear-open seams or perforation lines, can therefore be avoided.

The foam-film laminate according to the invention can optionally have a lacquer layer on the smooth or three-dimensionally structured surface of the cover layer. The lacquer layer can be advantageous for improving the surface properties, such as, for example, as regards the visual appearance or scratch resistance. The lacquer layer can be applied to the surface by conventional measures. The lacquer layer is preferably a polyurethane lacquer layer. The thickness of the optional lacquer layer can vary within wide ranges, but the lacquer layer preferably has a thickness in the range of from 1 to 25 μm, more preferably from 2 to 15 μm.

The foam-film laminate according to the invention can further optionally be provided with an adhesive layer or a primer on the side of the foam layer that is remote from the cover layer, that is to say on the lower side. The adhesive layer or primer can serve as a bonding layer or adhesion promoter for improving or permitting connection of the foam-film laminate to the component or a carrier to which the laminate is to be applied.

The foam-film laminate according to the invention is particularly suitable for coating an interior trim part for a motor vehicle, preferably a dashboard, wherein the foam-film laminate is preferably applied at least in the region of the airbag coverings or in the region of the tear-open seams of the airbag coverings. The foam-film laminate is suitable in particular for coating interior trim parts for a motor vehicle in the region of the airbag coverings or in the region of the tear-open seams of the airbag coverings.

Accordingly, the invention relates also to the use of the foam-film laminate according to the invention for the coating of components, preferably of components for the interior trim of motor vehicles, for example a dashboard, in particular for coating in the region of the airbag coverings or in the region of the tear-open seams of the airbag coverings.

The invention relates further to an interior trim part for a motor vehicle, preferably a dashboard, to which a foam-film laminate according to the invention is applied. The foam-film laminate is applied particularly preferably at least in the region of the airbag coverings or in the region of the tear-open seams of the airbag coverings.

The invention is to be explained in greater detail by means of comparative examples and exemplary embodiments.

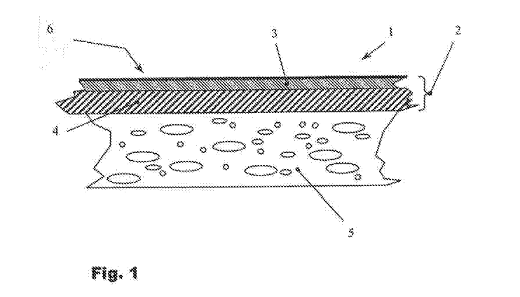

FIG. 1 shows the schematic structure of a foam-film laminate according to the invention.

FIG. 1 shows the structure of a schematic structure of a foam-film laminate according to the invention having a two-ply compact cover layer 2 comprising an outer layer 3 and an inner layer 4 which is adjacent to the foam layer 5. The film can be used for cladding a motor vehicle dashboard in the region of the passenger airbag. The thermoplastic foam-film laminate 1 is provided with an embossed three-dimensionally structured surface 6 on the outer cover layer, that is to say with a grain embossed on the outside by means of embossing by rolling.

### EXAMPLE 1

A foam-film laminate 1 according to the structure of FIG. 1 was produced with the following parameters. The cover layer 2 has a total thickness of 0.5 mm. The outer layer 3 is a TPO layer which has a density of 880 kg/m³ and a layer thickness of 0.2 mm. The inner layer 4 is a TPO layer which has a density of 900 kg/m³ and a layer thickness of 0.3 mm. The foam layer 5 is a foamed polyolefin layer which has a density of 570 kg/m³ and a layer thickness of 0.9 mm.

### COMPARATIVE EXAMPLE 1

As a comparison, a two-ply compact film was produced with the following parameters. The outer layer of the compact film is a TPO layer which has a density of 880 kg/m³ and a layer thickness of 0.5 mm. The inner layer of the compact film is a TPO layer which has a density of 880 kg/m³ and a layer thickness of 0.9 mm.

### COMPARATIVE EXAMPLE 2

As a further comparison, a two-ply film comprising a compact layer and a foam layer was produced with the following parameters. The (outer) compact layer of the film is a TPO layer which has a density of 880 kg/m³ and a layer thickness of 0.5 mm. The (inner) foam layer of the film is a PP foam which has a density of 67 kg/m³ and a layer thickness of 2 mm.

### Testing of the Ultimate Elongation Behavior

The ultimate elongation of the films in the longitudinal direction according to example 1 and comparative examples 1 and 2 was tested by means of tensile elongation tests in accordance with DIN 527-3 in dependence on the temperature. The test speed was approximately 0.3 m/s. The results obtained are listed in the following table.

TABLE
Ultimate elongation of the films at
different temperatures in [%]

| | | Comp. | | Comp. |
|---|---|---|---|---|
| | | ex. 1 | Ex. 1 | ex. 2 |
| −35° | C. | 90 | 90 | 20 |
| 23° | C. | 450 | 400 | 500 |
| 85° | C. | 900 | 550 | 700 |
| 120° | C. | 1100* | 1200* | 600 |
| 150° | C. | 1100* | 900 | 300 |
| 180° | C. | 1000 | 800 | 200 |

*Breaking without crack formation

The tests show that the film according to the invention of example 1 has a reduced ultimate elongation as compared with the compact film according to comparative example 1. On the other hand, the stability of example 1 is sufficient to permit thermal shaping with relatively high degrees of stretching, for example greater than 200%. By contrast, the ultimate elongation of the foam film according to comparative example 2 is reduced significantly at higher temperatures. Thermal shaping with relatively high degrees of stretching is therefore not possible with the foam film according to comparative example 2.

The test speed (approximately 0.3 m/s) used for the test in the laboratory differs too greatly from the actual opening times of up to 90 m/s in the case of actual airbag firing for it to be possible to derive from the laboratory tests a correlation of the results with the behavior during the actual airbag firing test.

### Airbag Firing Tests

The opening behavior of the films according to example 1 and comparative examples 1 and 2 in an actual airbag firing test was tested. To that end, the respective films were applied to an airbag covering and the airbag was then opened. A PUR foam was applied to the back of the compact film according to comparative example 1, the foam at the same time being connected to the component or carrier.

The film according to the invention of example 1 showed a tearing behavior upon firing of the airbag which met the requirements for an airbag system. A weakening on the rear side is not necessary.

The compact film according to comparative example 1 does not break immediately when the airbag is fired, owing to the higher strength and extensibility, but is first stretched. The upper layers of the PUR foam thereby break, which has the result that further extensible material becomes available. The total distance over which stretching must take place before breaking occurs becomes significantly longer, so that the time taken for the airbag to open is lengthened to an inadmissible degree. Flying particles are possible, which is inadmissible. It is therefore not possible to use the compact film for an airbag covering without a weakening on the rear side of the film.

The film according to comparative example 2 shows acceptable opening behavior upon firing of the airbag. However, as has been shown above, this film is not suitable for producing a complex component with high degrees of stretching of over 200%.

### COMPARATIVE EXAMPLE 3

In order to test variants, an alternative was tested. To that end, a film was produced according to example 1, except that the inner layer 4 was foamed. This variant shows disadvantages compared with the film according to the invention. The tearing behavior upon firing of the airbag without a weakening was acceptable, but there was in particular no grain stability or moldability.

### COMPARATIVE EXAMPLE 4

In order to test variants, a further alternative was tested. To that end, a film was produced according to example 1, except that the layer 5 was not in the form of a foamed layer but was in compact form analogously to the inner layer 4. The strength of the structure as a whole is thereby increased. However, increasing the strength leads to far-reaching foam debris when the airbag opens and to the uncontrollable emergence of the airbag sack. In some cases, the airbag sack was seen to migrate beneath the decorative film and emerge in an undefined manner.

1.-14. (canceled)

15. A foam sheet laminate comprising a compact cover layer with a three-dimensionally textured surface on a top and a foam layer on an underside of the compact cover layer;
wherein the compact cover layer comprises an outer layer and an inner layer, wherein the outer layer has a thickness in the range of 0.05 to 0.3 mm, wherein the inner layer has a thickness in the range of 0.2 to 0.6 mm, wherein the inner layer is bonded to the foam layer, wherein the foam layer has a thickness in the range of 0.5 to 2 mm and a density of at least 350 kg/m; and,
wherein under the conditions of an air surplus, elongation at break of the inner layer and the foam layer is smaller than elongation at break of the outer layer, and wherein airbag relevant conditions are defined as a temperature range between −35 and +85° C. and high strain rates occurring due to the opening of an airbag speeds of up to 90 m/s.

16. The foam film laminate according to claim 15, wherein melt flow index (MFI) of the inner layer is greater than the melt flow index (MFI) of the outer layer, and wherein melt flow index (MFI) according to DIN EN ISO 1133 is determined at a temperature of 230° C. and a load of 2.16 kg.

17. The foam film laminate according to claim 15, wherein difference between the melt flow index (MFI) of the inner layer and the melt flow index (MFI) of the outer layer is at least 1 g/10 min.

18. The foam film laminate according to claim 17, wherein the difference between the melt flow index (MFI) of the inner layer and the melt flow index (MFI) of the outer layer is at least 2 g/10 min.

19. The foam film laminate according to claim 15, wherein the outer layer has a melt flow index (MFI) of less than 1 g/10 min, and the inner layer has a melt flow index (MFI) of greater than 3 g/10 min.

20. The foam film laminate according to claim 15, wherein the foam layer has a density in a range of 350 to 700 kg/m³.

21. The foam film laminate according to claim 15, wherein the outer layer, the inner layer and the foam layer are each a layer of plastic, wherein the plastic is independently selected from thermoplastic polyolefin (TPO), polyurethane (PU), polyvinylchloride (PVC) or a combination of two or more thereof.

22. The foam film laminate according to claim 15, wherein the foam layer is a physically foamed layer.

23. The foam film laminate according to claim 15, wherein a polyurethane coating layer is disposed the three-dimensionally structured surface, disposed on a side of the foam layer which is opposite of the compact cover layer, or combination of both.

24. The foam film laminate according to claim 15, wherein the foam foil laminate is formed into component by applying the foam sheet laminate in a shaping process on a carrier which corresponds to the shape of the component.

25. A foam sheet laminate comprising a compact cover layer with a smooth surface on a top and a foam layer on an underside of the compact cover layer;
wherein the compact cover layer comprises an outer layer and an inner layer, wherein the outer layer has a thickness in the range of 0.05 to 0.3 mm, wherein the inner layer has a thickness in the range of 0.2 to 0.6 mm, wherein the inner layer is bonded to the foam layer, wherein the foam layer has a thickness in the range of 0.5 to 2 mm and a density of at least 350 kg/m; and,
wherein under the conditions of an air surplus, elongation at break of the inner layer and the foam layer is smaller than elongation at break of the outer layer, and wherein airbag relevant conditions are defined as a temperature range between −35 and +85° C. and high strain rates occurring due to opening of an airbag speeds of up to 90 m/s.

26. The foam film laminate according to claim 25, wherein melt flow index (MFI) of the inner layer is greater than the melt flow index (MFI) of the outer layer, and wherein melt flow index (MFI) according to DIN EN ISO 1133 is determined at a temperature of 230° C. and a load of 2.16 kg.

27. The foam film laminate according to claim 25, wherein difference between the melt flow index (MFI) of the inner layer and the melt flow index (MFI) of the outer layer is at least 1 g/10 min.

28. The foam film laminate according to claim 25, wherein the outer layer has a melt flow index (MFI) of less than 1 g/10 min, and the inner layer has a melt flow index (MFI) of greater than 3 g/10 min.

29. The foam film laminate according to claim 25, wherein the foam layer has a density in a range of 350 to 700 kg/m³.

30. The foam film laminate according to claim 25, wherein the outer layer, the inner layer and the foam layer are each a layer of plastic, wherein the plastic is independently selected from thermoplastic polyolefin (TPO), polyurethane (PU), polyvinylchloride (PVC) or a combination of two or more thereof.

31. The foam film laminate according to claim 25, wherein the foam layer is a physically foamed layer.

32. The foam film laminate according to claim 25, wherein a polyurethane coating layer is disposed on the smooth or three-dimensionally structured surface, disposed on a side of the foam layer which is opposite of the compact cover layer, or combination of both.

33. The foam film laminate according to claim 25, wherein the foam foil laminate is formed into component by applying the foam sheet laminate in a shaping process on a carrier which corresponds to the shape of the component.

34. A motor vehicle interior airbag cover comprising a foam film laminate, the foam film laminate comprising a compact cover layer with a surface on a top and a foam layer on an underside of the compact cover layer;
wherein the compact cover layer comprises an outer layer and an inner layer, wherein the outer layer has a thickness in the range of 0.05 to 0.3 mm, wherein the inner layer has a thickness in the range of 0.2 to 0.6 mm, wherein the inner layer is bonded to the foam layer, wherein the foam layer has a thickness in the range of 0.5 to 2 mm and a density of at least 350 kg/m; and,
wherein under the conditions of an air surplus, elongation at break of the inner layer and the foam layer is smaller than elongation at break of the outer layer, and wherein airbag relevant conditions are defined as a temperature range between −35 and +85° C. and high strain rates occurring due to opening of an airbag speeds of up to 90 m/s.
